(19) United States
(12) Patent Application Publication
(10) Pub. No.: US 2017/0338565 A1
(43) Pub. Date: Nov. 23, 2017

(54) APPARATUS FOR INTERACTING WITH ELECTROMAGNETIC ENERGY

(71) Applicant: Michael Lee Morrissey, Pace, FL (US)

(72) Inventor: Michael Lee Morrissey, Pace, FL (US)

(21) Appl. No.: 15/672,804

(22) Filed: Aug. 9, 2017

Related U.S. Application Data
(63) Continuation-in-part of application No. 14/950,023, filed on Nov. 24, 2015.
(60) Provisional application No. 62/085,517, filed on Nov. 29, 2014.

(51) Int. Cl. H01Q 9/40; H01Q 13/18; H01Q 1/40; H01Q 21/28; H01Q 1/22

(52) U.S. Cl. CPC H01Q 9/40; H01Q 21/28; H01Q 1/22; H01Q 1/40; H01Q 13/18

(57) ABSTRACT

In some embodiments, an apparatus for conducting electromagnetic energy may comprise four base linear conductors which are coupled together to form a right rectangle which may be supported by a base. Four slant linear conductors may be coupled to the four base linear conductors. Each slant linear conductor may be coupled to an intersection of two base linear conductors, and each slant linear conductor may also be coupled to the other three slant linear conductors to form a right pyramid shape with an apex. An annular element may be coupled to and encircling the apex formed by the slant linear conductors. A central linear conductor may be coupled to the annular element below the apex, extending perpendicularly towards the base, and coupled to the base. A slant crystal may be coupled to each slant linear conductor and a vertical crystal may be coupled to the central linear conductor.

### CROSS REFERENCE TO RELATED APPLICATIONS

This application is a continuation-in-part of pending U.S. Non-provisional application Ser. No. 14/950,023 filed Nov. 24, 2015 which in turn claims priority to and the benefit of the filing date of U.S. Provisional Application No. 62/085,517, filed on Nov. 29, 2014, which is also hereby incorporated by reference in its entirety.

### FIELD OF THE INVENTION

This patent specification relates to the field of energy collection and energy direction. More specifically, this patent specification relates to devices and apparatuses for interacting with electromagnetic energy.

### APPENDIX TO THE SPECIFICATION

This application contains an appendix labeled as “Appendix_A”. The entire contents of which are hereby incorporated by reference in their entirety.

### BACKGROUND

The pyramidal shape has been used to collect natural energy for a very long time. It is commonly known that the strongest energy field exists in the center, or resonant chamber, of the pyramid shape and to gain the use of the maximum energy field it has been necessary to place objects inside the pyramid shape. This has limited the effective use of the maximum energy.

In modern times science has come to realize the ability of rock quartz crystals to collect and amplify energy and they have been used in many fields. Experiments conducted using crystals on the vertical elements of the antenna did increase the energy collection, but did not resolve the problem of directing the energy from the resonant chamber. Without being able to direct the energy from the resonant chamber, these antennas were limited to collecting energy generally in their respective centers. This limits the application of energy to objects that are centrally placed within these antennas. Furthermore, precise positioning of objects in relation to these antennas is also required.

Therefore, a need exists for a novel antenna apparatus for conducting electromagnetic energy that allows for the maximum energy collection to be used by objects that may be conveniently placed above or below the antenna. A further need also exists for novel antenna apparatuses that are able to direct the collected energy from the resonant chamber. There is a further need for novel antenna apparatuses that are not limited to the application of energy solely to objects that are centrally placed within these antennas. Finally, there exists a need for novel antenna apparatuses that do not require precise positioning of objects in relation to these antennas.

### BRIEF SUMMARY OF THE INVENTION

A natural energy apparatus used to conduct naturally occurring electromagnetic energy without the use of any moving parts or additional energy is provided. The apparatus for conducting electromagnetic energy may be used as an to collect and conduct natural occurring electromagnetic energies. In preferred embodiments, the apparatus may be configured in a right quadrilateral pyramid shape as the Great Pyramid of Cheops in Giza. The apparatus may comprise an annular element above encircling the apex of the apparatus 100 that may be electromagnetically coupled to a central linear conductor that preferably extends vertically through the centerline of the pyramid shape of the apparatus, a parasitic reflector element is created causing the modification of the focal point of the electromagnetic energy collected which may then be redirected in the up and down direction relative to the apparatus.

In some embodiments, an apparatus for conducting electromagnetic energy may comprise four base linear conductors which are coupled together to form a right rectangle which may be supported by a base. Four slant linear conductors may be coupled to the four base linear conductors. Each slant linear conductor may be coupled to an intersection of two base linear conductors, and each slant linear conductor may also be coupled to the other three slant linear conductors to form a right pyramid shape with an apex. An annular element may be coupled to and encircling the apex formed by the slant linear conductors. A central linear conductor may be coupled to the annular element below the apex, and the central linear conductor may extend perpendicularly towards the base and may also be coupled to the base. A slant crystal may be coupled to each slant linear conductor and a vertical crystal may be coupled to the central linear conductor.

In further embodiments, an apparatus may comprise four base linear conductors which are coupled together to form a right rectangle which may be supported by a base and each base linear conductor may be electromagnetically isolated from the two other base linear conductors to which it is coupled. Four slant linear conductors may be coupled to the four base linear conductors. Each slant linear conductor may be coupled to an intersection of two base linear conductors, and each slant linear conductor may also be coupled to the other three slant linear conductors to form a right pyramid shape with an apex. The slant linear conductors may be electromagnetically isolated from the base linear conductors and from the other slant linear conductors. An annular element may be coupled to and encircling the apex formed by the slant linear conductors, and the annular element may be electromagnetically isolated from the slant linear conductors. A central linear conductor may be coupled to the annular element below the apex, and the central linear conductor may extend perpendicularly towards the base and may also be coupled to the base. The central linear conductor may be in electromagnetic communication with the annular element. A slant crystal may be coupled to each slant linear conductor and a vertical crystal may be coupled to the central linear conductor.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a perspective view of an example of an apparatus for conducting electromagnetic energy according to various embodiments described herein.

FIG. 2 illustrates an elevation view of an example of an apparatus for conducting electromagnetic energy according to various embodiments described herein.

FIG. 3 shows another perspective view of an example of an apparatus for conducting electromagnetic energy according to various embodiments described herein.

FIG. 4 depicts a perspective view an example of a corner coupling element according to various embodiments described herein.

FIG. 5 illustrates a perspective view an example of an apex coupling element according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

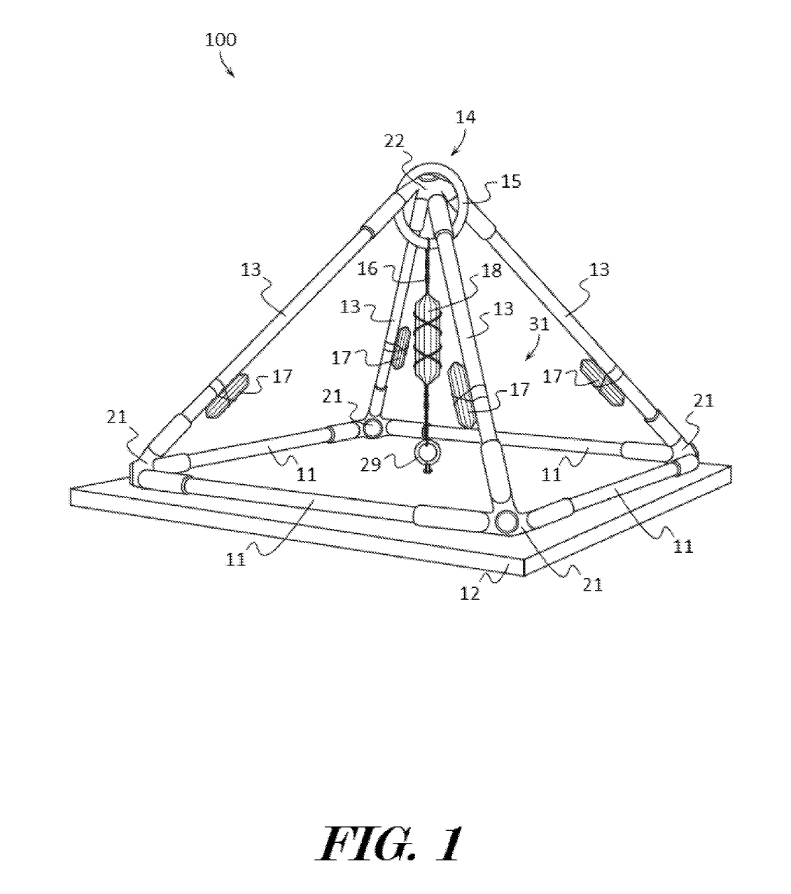

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

A new apparatus for conducting electromagnetic energy is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

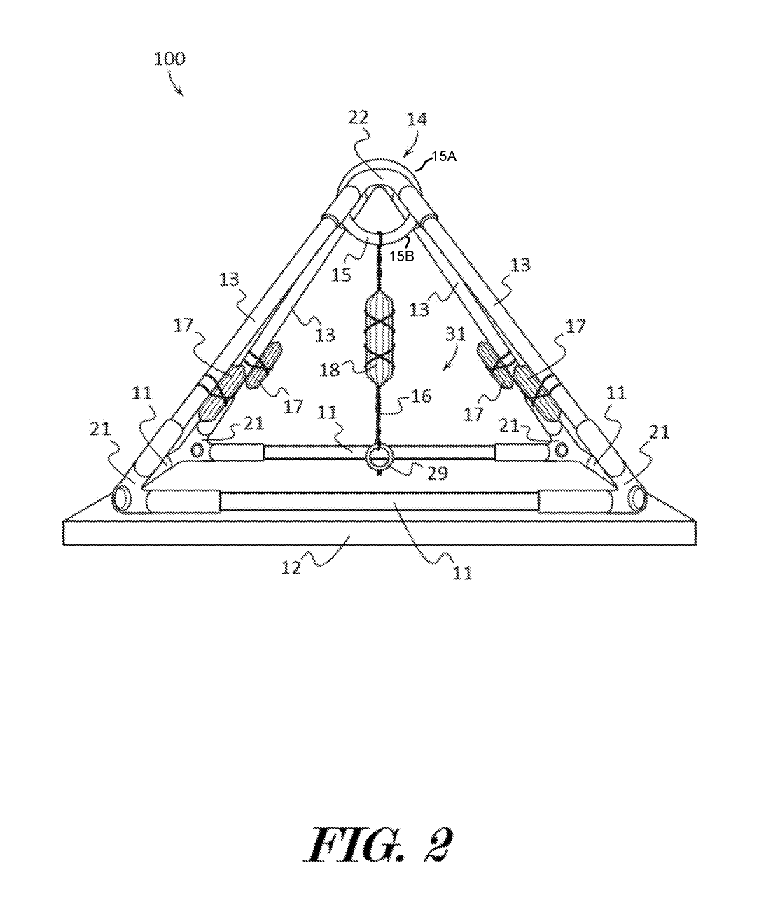

The present invention will now be described by example and through referencing the appended figures representing preferred and alternative embodiments. FIGS. 1-3 illustrate an example of an apparatus for interacting with or even conducting electromagnetic energy (“the apparatus”) 100 according to various embodiments. It is well known in the art that there are many positive reason and uses for interacting with electromagnetic energy for a variety of technical, medical, and even spiritual benefits. In one example, the apparatus 100 comprises four base linear conductors 11 which are coupled together to form a right rectangle and/or square which may be supported by a base 12. Four slant linear conductors 13 may be coupled to the four base linear conductors 11. Each slant linear conductor 13 may be coupled to an intersection of two base linear conductors 11, and each slant linear conductor 13 may also be coupled to the other three slant linear conductors 13 to form a right pyramid shape with an apex 14. A ring shaped annular element 15 may be coupled to and encircling the apex 14 formed by the slant linear conductors 13, the ring shaped annular element having a hollow or empty center to position the apex 14. In the figures show, a top portion 15A of the annular element is above the apex 14 while a bottom portion 15B is below the apex 14. A central linear conductor 16 may be coupled to the annular element 15 below the apex 14, and the central linear conductor 16 may extend perpendicularly towards the base 12 and may also be coupled to the base 12. In this regard, the linear conductor 16 is preferably coupled to a flat base 12 at a position or location that is actually below the slant linear conductors 13 and below the slant crystals 17. The slant crystal 17 may be coupled to each slant linear conductor 13, and a vertical crystal 18 may be coupled to the central linear conductor 16.

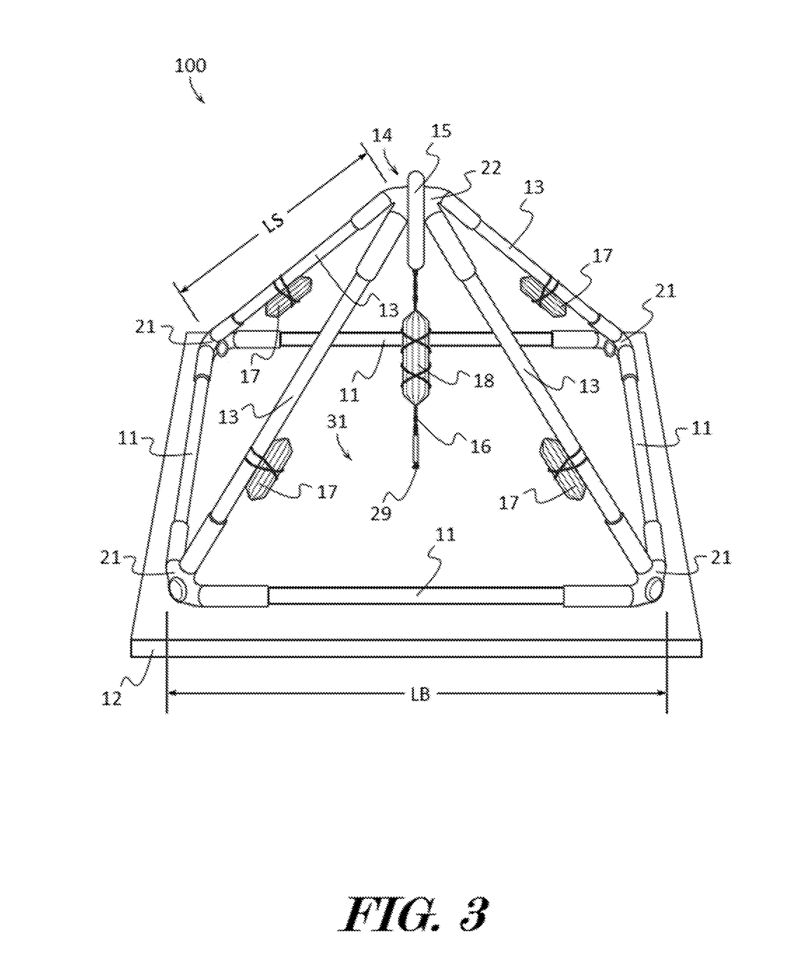

In preferred embodiments, the apparatus 100 may be configured in the shape of a right pyramid with the apex directly above the centroid of its base. As shown in FIG. 3, the apparatus 100 may comprise a right square pyramid shape in which the base of the pyramid shape comprises a base length (LB) and the slant edges of the pyramid shape comprise a slant length (LS). In preferred embodiments, the ratio of the length of LS to the length of LB is approximately 0.95. In other embodiments, the ratio of the length of LS to the length of LB is approximately 0.91 to 0.99. In some embodiments, LB may be approximately 5.07 to 5.13 inches, although other lengths may be used. The shape of the base of the right pyramid formed by the apparatus 100 may be rectangular and preferably a square. Furthermore, the pyramid shape formed by the apparatus 100 may be a right square pyramid shape based on the dimensions of the Great Pyramid of Cheops in Giza. In further embodiments, the slant linear conductors 13 and base linear conductors 11 may be configured to form a right square pyramid shape with a slope of 51.34 to 52.34 degrees as established in the Great Pyramid of Cheops in Giza. In other embodiments, the slant linear conductors 13 and base linear conductors 11 form a right pyramid shape with a slope of 46 to 56 degrees. The length of the slant linear conductors 13 would be determined by the length used for the base linear conductors 11 in order to maintain the preferred angle. Additional preferred embodiments may be scaled larger or smaller. Other embodiments may use different lengths and angles to create alternative 5 sided pyramid shapes in different sizes or scales.

The base 12 may be generally planar in shape to support the base linear conductors 11 in a generally planar orientation and also to establish and maintain a relatively level and flat surface to support one or more corner coupling elements 21. Any material may be used to form the base 12, while in preferred embodiments, the base 12 may be made from a non-electromagnetically conductive material such as acrylic, high-density polyethylene (HDPE), polyvinyl chloride (PVC), polypropylene (PP), Polystyrene (PS), Polycarbonate (PC), other types of non-conductive plastics, ceramics, wood, carbon fiber, glass, or any other suitable natural or synthetic material including combinations of materials which are generally non-conductive to electromagnetic energy. In further embodiments, the base 12 may be shaped and sized to be equal to or larger than the right rectangle or square formed by the base linear conductors 11. In some embodiments, the base 12 may be made from acrylic plastic with a thickness of 0.21 to 0.255 inches. In further embodiments, the base 12 may be square in shape with the length of each side of the base 12 being approximately 5.77 to 5.79 inches although other materials and dimensions may be used. In still further embodiments, the base linear conductors 11 and/or the corner coupling elements 21 may be coupled to the base 12 with adhesive, mounting plates or blocks, fasteners, a housing which may encompass the apparatus 100, or any other suitable coupling method.

In preferred embodiments, the base linear conductors 11 and/or the slant linear conductors 13 may be made from or comprise copper, brass, other metals and metal alloys, or other electromagnetically conductive materials. In other embodiments, the base linear conductors 11 and/or the slant linear conductors 13 may comprise any other suitable rigid material or combination of materials that are preferably electromagnetically conductive.

In some embodiment, the base linear conductors 11 may comprise copper round rod type C110. In this and preferred embodiments, the length of the four base linear conductors 11 may be equal and may be 4.506 to 4.566 inches with a diameter of 0.177 to 0.197 inches, although they may be configured in other lengths and diameters. In preferred embodiments, the apparatus 100 may comprise a quantity of four base linear conductors 11 of a length and the distance between the parallel and opposite base linear conductors 11 may be equal to ensure the base linear conductors 11 create a quadrilateral and preferably a square base for the preferred right square pyramid shape formed by the apparatus 100.

In some embodiment, the slant linear conductors 13 may comprise copper round rod type C110. In this and preferred embodiments, the length of the slant linear conductors 13 may be 4.284 to 4.344 inches with a diameter of 0.177 to 0.197 inches, although they may be configured in other lengths and diameters. In preferred embodiments, the apparatus may comprise a quantity of four slant linear conductors 13 which may be coupled together to form an apex 14.

In other preferred embodiments, the slant linear conductors 13 and the base linear conductors 11 may be configured in other dimensions with the slant linear conductors 13 dimensions and the base linear conductors 11 dimensions comprising a similar ratio to the dimensions of the Great Pyramid of Cheops in Giza. In other embodiments, the slant linear conductors 13 and the base linear conductors 11 may be configured in other dimensions.

In preferred embodiments, the base linear conductors 11 may be coupled together to form a right rectangle or square and each base linear conductor 11 may be electromagnetically isolated from the two other base linear conductors 11 to which it is coupled so that each base linear conductor 11 is electromagnetically isolated from the other base linear conductors 11. In some embodiments, two base linear conductors 11 may be coupled together with a corner coupling element 21 and the apparatus 100 may comprise four corner coupling elements 21 which may be made from a non-electromagnetically conductive material. In further embodiments, each corner coupling element 21 may also receive a slant linear conductor 13 and may couple the slant linear conductor 13 to two base linear conductors 11. A corner coupling element 21 may be made from a non-electromagnetically conductive material, and may be used to couple and electromagnetically isolate two base linear conductors 11 and a slant linear conductor 13 from each other.

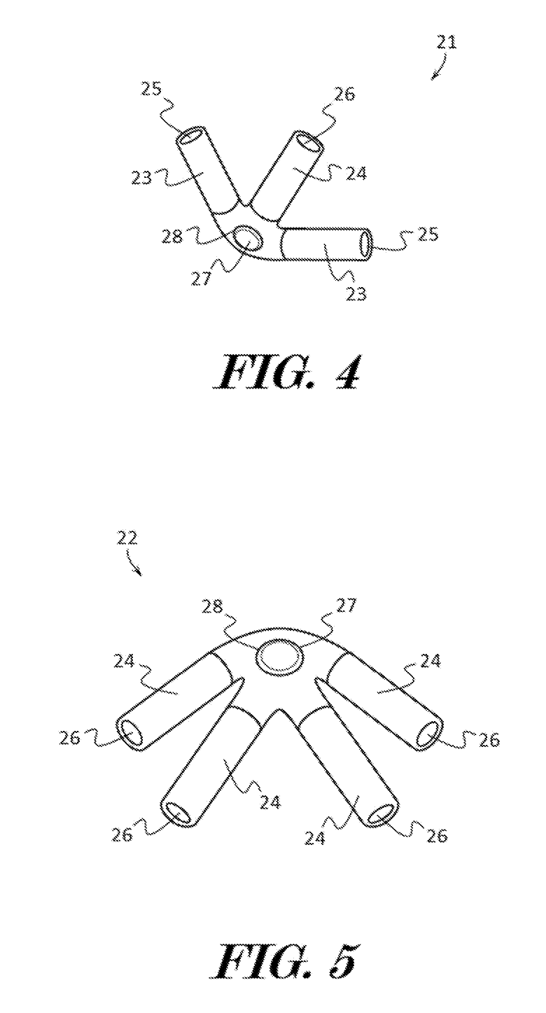

As perhaps best shown in FIG. 4, in some embodiments, a corner coupling element 21 may be made from a non-electromagnetically conductive material, such as vinyl tubing, silicone tubing, acrylic tubing, plastic tubing, or the like, and may include two linear arms 23 and one slant arm 24. In further embodiments, the linear arms 23 may be made from a first length of tubular shaped non-electromagnetically conductive material and the slant arm 24 may be made from a second length of tubular shaped non-electromagnetically conductive material. The first length of material, forming the two linear arms 23, may be coupled to the second length of material, forming the slant arm 24, with a coupling fastener 27. A coupling fastener 27 may comprise a solid brass double-cap rivet with 0.25 inch shank and 0.25 cap although any other suitable fastener may be used. In further embodiments, a corner coupling element 21 may be made from any other non-electromagnetically conductive material. In still further embodiments, the two linear arms 23 and one slant arm 24 of a corner coupling element 21 may be integrally formed or molded together. In even further embodiments, a corner coupling element 21 may be configured in any other shape which may be used to couple two base linear conductors 11 and a slant linear conductor 13 while preferably electromagnetically isolating the two base linear conductors 11 and slant linear conductor 13 from each other.

Each linear arm 23 may comprise a linear aperture 25 and a slant arm 24 may comprise a slant aperture 26. A linear aperture 25 may be configured to be complementary in shape to a base linear conductor 11 to allow a portion of the base linear conductor 11 to be inserted into the linear aperture 25. A base linear conductor 11 may be coupled to a corner coupling element 21 by press fitting a portion of the base linear conductor 11 into the linear aperture 25 optionally with the addition of an adhesive. A slant aperture 26 may be configured to be complementary in shape to a slant linear conductor 13 to allow a portion of the slant linear conductor 13 to be inserted into the slant aperture 26. A slant linear conductor 13 may be coupled to a corner coupling element 21 by press fitting a portion of the slant linear conductor 13 into the slant aperture 26 optionally with the addition of an adhesive.

In some exemplary embodiments, the two linear arms 23 may be made of vinyl tubing of approximately 1.97 to 2.03 inches in length, forming linear apertures 25 and slant apertures 26 with inside diameters of approximately 0.145 to 0.205 inches, and wall tubing outside diameter thickness of 0.02 to 0.04 inches. The slant arm 24 may be made from a second length of vinyl tubing of approximately 0.97 to 1.03 inches in length. The linear arms 23 may be coupled to the slant arm 24 with a coupling fastener 27 that extends through a fastener aperture 28 in the first and second length of vinyl tubing. A fastener aperture 28 preferably may comprise a hole extending through the two lengths of tubing with a diameter may be approximately 0.09 to 0.11 inches through which the coupling fastener 27 may be inserted. The fastener aperture 28 may be located on the centerline of the linear arm 23 tubing and approximately 0.97 to 1.03 inches, from an end of the tubing. Preferably, the fastener aperture 28 of the linear arm 23 tubing may be within ±0.15 inches of the centerline of the tubing. The fastener aperture 28 may be located on the centerline of the slant arm 24 tubing and approximately 0.115 to 0.135 inches, from an end of the tubing. Preferably, the fastener aperture 28 of the slant arm 24 may be within ±0.15 inches of the centerline of the tubing.

As perhaps best shown in FIG. 5, in some embodiments, an apex coupling element 22 may be made from a non-electromagnetically conductive material similar to a corner coupling element 21 and may include four slant arms 24. In further embodiments, two slant arms 24 may be made from a first length of tubular shaped non-electromagnetically conductive material and the other two slant arms 24 may be made from a second length of tubular shaped non-electromagnetically conductive material. The first length of material, forming two slant arms 24, may be coupled to the second length of material, forming the other two slant arms 24, with a coupling fastener 27. In further embodiments, an apex coupling element 22 may be made from any other non-electromagnetically conductive material. In still further embodiments, the slant arms 24 of an apex coupling element 22 may be integrally formed or molded together. In even further embodiments, an apex coupling element 22 may be configured in any other shape which may be used to couple four slant linear conductors 13 to form the apex 14 while preferably electromagnetically isolating the slant linear conductors 13 from each other.

Each slant arm 24 may comprise a slant aperture 26. A slant aperture 26 may be configured to be complementary in shape to a slant linear conductor 13 to allow a portion of the slant linear conductor 13 to be inserted into a slant aperture 26. A slant linear conductor 13 may be coupled to an apex coupling element 22 by press fitting a portion of the slant linear conductor 13 into the slant aperture 26 optionally with the addition of an adhesive.

In some exemplary embodiments, two slant arms 24 may be made of vinyl tubing of approximately 1.97 to 2.03 inches in length, forming slant apertures 26 with inside diameters of approximately 0.145 to 0.205 inches, and wall tubing outside diameter thickness of 0.02 to 0.04 inches. Two slant arms 24 may be made from a first length of vinyl tubing and the other two slant arms 24 may be made from a second length of vinyl tubing. The first length of vinyl tubing may be coupled to the second length of vinyl tubing with a coupling fastener 27 that extends through a fastener aperture 28 in the first and second length of vinyl tubing. A fastener aperture 28 preferably may comprise a hole through lengths of tubing and the diameter may be approximately 0.09 to 0.11 inches through which the coupling fastener 27 may be inserted. The fastener aperture 28 may be located on the centerline of the each tubing and approximately 0.97 to 1.03 inches, from the end of each length of tubing. Preferably, the fastener aperture 28 may be within ±0.15 inches of the centerline of the tubing.

In alternative embodiments, corner coupling elements 21 and an apex coupling element 22 may be constructed by other methods to meet the requirements of insulating and positioning the base linear conductors 11 and the slant linear conductors 13 from each other, such as drilling holes in a block of non-conductive material to include, but not limited to, plastic or wood in the proper locations with proper angles to form a right pyramid.

In some embodiments, the apparatus 100 may comprise an annular element 15 which may be made from a conductive material such as copper, brass, other metals and metal alloys, or any other conductive material. In preferred embodiments, an annular element 15 may be coupled to and encircling the apex 14 formed by the slant linear conductors 13. As perhaps best shown in FIG. 3, the annular element 15 may encircle the apex 14 and be oriented perpendicular to the base 12 while also being oriented parallel and in the same plane as the apothem of the right pyramid formed by the apparatus 100. Additionally, the annular element 15 may preferably be positioned within the centerline of the apothem within ±0.150 inches. In some embodiments, a conducting or non-conducting wire material may be wrapped around portions of the annular element 15 and apex coupling element 22 to couple the annular element 15 to the apex 14. In other embodiments, the annular element 15 may be coupled to the apex 14 with any other type of fastener, adhesive, other connection method, and the like while preferably electromagnetically insulating the annular element 15 from the slant linear conductors 13.

In some embodiments, the annular element 15 may be made of solid brass or any other electromagnetically conductive material and comprise an annular or ring shape preferably with an inside diameter of 0.72 to 0.78 inches and an outside diameter of 1.045 to 1.105 inches although other sizes may be used. In further embodiments, the annular element 15 may be coupled to the apex coupling element 22 and therefore the apex 14 with two lengths of 0.020 inch diameter copper wire 3.5 to 4.5 inches in length. Optionally, the wire may be wrapped first around the top of the annular element 15 and then around the apex coupling element 22. Preferably, once the centerline is confirmed, an adhesive may be applied to further couple the annular element 15 to the apex coupling element 22 and therefore to the apex 14.

In some embodiments, a central linear conductor 16 may be coupled to the annular element 15 and/or to the apex coupling element 22 below the apex 14. In preferred embodiments, the central linear conductor 16 may extend perpendicularly towards the base 12 and may be coupled to the base 12 centrally within the rectangle or square formed by the base linear conductors 11. The central linear conductor 16 may be made from an electromagnetically conductive material, such as copper, brass, other metals and metal allows, or any other electromagnetically conductive material. The central linear conductor 16 may be coupled, such as by contacting, to the annular element 15 to allow the central linear conductor 16 to be in electromagnetic communication with the annular element 15. In further embodiments, the central linear conductor 16 may be made from an electromagnetically conductive material such as copper wire approximately 0.015 to 0.025 inches in diameter.

The central linear conductor 16 may be coupled at a first end to the apex coupling element 22, and therefore to the apex 14, at a first end and coupled to the base 12 at a second end. In some embodiments, the central linear conductor 16 may be coupled to the base 12 with a base fastener 29, by integrally forming a portion of the central linear conductor 16 with the base 12, with an adhesive, or with any other suitable coupling method. For example, the base fastener 29 may comprise a threaded eyehook or loop coupled to the base 12 and the central linear conductor 16 may comprise a length of metal wire which may be wrapped around or otherwise coupled to the threaded eyehook or loop.

A vertical crystal 18 may be coupled to the central linear conductor 16 so that the vertical crystal 18 may be positioned centrally under the apex 14 of the right pyramid formed by the apparatus 100. In preferred embodiments, the vertical crystal 18 may be coupled to the central linear conductor 16 so that the vertical crystal 18 and the central linear conductor 16 may be in electromagnetic communication. For example, a length of electromagnetically conductive material, such as copper wire or other metal wire, may be wrapped around portions of the vertical crystal 18 and the central linear conductor 16 to couple the two together while also providing electromagnetic communication between the two. In further embodiments, the vertical crystal 18 may be coupled to the central linear conductor 16 approximately 1.25 to 1.75 inches above the base 12, while in other embodiments, the vertical crystal 18 may be coupled anywhere on the central linear conductor 16 such as centrally between the bottom of the annular element 15 and the base 12.

The apparatus 100 may comprise four slant crystals 17 and each slant crystal 17 may be coupled to a slant linear conductor 13. In preferred embodiments, a slant crystal 17 may be coupled to a slant linear conductor 13 to allow electromagnetic communication between the slant crystal 17 and the slant linear conductor 13. For example, a length of electromagnetically conductive material, such as copper wire or other metal wire, may be wrapped around portions of a slant crystal 17 and the slant linear conductor 13 to couple the two together while also providing electromagnetic communication between the two. In further embodiments, each slant crystal 17 may be coupled to a slant linear conductor 13 at a location closer to the corner coupling element 21 than to the apex coupling element 22. The location of each slant crystal 17 on each slant linear conductor 13 should be based on the golden ratio by being closer to the base 12. For example, a slant crystal 17 may be coupled approximately 1.35 to 1.85 inches from the lower end of a slant linear conductor 13 as measured from the lengthwise center of the slant crystal 17. Also each slant crystal 17 should preferably be coupled to a slant linear conductor 13 within the interior 31 of the apparatus 100 and facing the vertical crystal 18.

In some embodiments, the vertical crystal 18 and/or slant crystals 17 may be made from natural crystal such as natural silicon dioxide rock quartz. In other embodiments, the vertical crystal 18 and/or slant crystals 17 may be made from any other natural or synthetic crystal including formed and shaped crystals. In preferred embodiments, a vertical crystal 18 and/or a slant crystal 17 may comprise a Grade B Natural Rock Quartz with clarity and a point on one end. In further preferred embodiments the size of a slant crystal 17 may range from approximately 0.75 to 1.25 inches in length with a diameter of approximately 0.15 inches or larger although other sizes may be used.

While some materials have been provided, in other embodiments, the elements that comprise the apparatus 100 such as the base linear conductors 11, base 12, slant linear conductors 13, annular element 15, central linear conductor 16, corner coupling element 21 and/or apex coupling element 22 may be made from durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the apparatus 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the apparatus 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the apparatus 100 may be coupled by being one of connected to and integrally formed with another element of the apparatus 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

### Definitions

As used herein the term “antenna” or “apparatus” shall not have the same meaning as is commonly found in the art. Instead, the term “antenna” or “apparatus” shall mean a pyramid shaped device which comprises four base linear conductors coupled to four slant linear conductors, and a central linear conductor coupled to an annular element as shown by the figures and described herein.

What is claimed is:

1. An apparatus, the apparatus comprising:
four base linear conductors coupled together to form a right rectangle;
a base supporting the base linear conductors;
four slant linear conductors, wherein each slant linear conductor is coupled to an intersection of two base linear conductors and also coupled to the other three slant linear conductors to form a right pyramid shape with an apex;
a ring shaped annular element coupled to and encircling the apex formed by the slant linear conductors so that a top portion of the ring shaped annular element is above the apex and a bottom portion of the ring shaped annular element is below the apex;
a central linear conductor coupled to the annular element below the apex, wherein the central linear conductor extends perpendicularly towards the base and is coupled to the base;
four slant crystals, wherein each slant crystal is coupled to a slant linear conductor; and
a vertical crystal, wherein the vertical crystal is coupled to the central linear conductor.

2. The apparatus of claim 1, wherein each base linear conductor is electromagnetically isolated from the two other base linear conductors to which it is coupled.

3. The apparatus of claim 1, wherein each slant linear conductor is electromagnetically isolated from the base linear conductors and from the other slant linear conductors.

4. The apparatus of claim 1, wherein the annular element is electromagnetically isolated from the slant linear conductors.

5. The apparatus of claim 1, wherein the central linear conductor is in electromagnetic communication with the annular element.

6. The apparatus of claim 1, wherein the slant crystals are natural crystals.

7. The apparatus of claim 1, wherein the vertical crystal is a natural crystal.

8. The apparatus of claim 1, wherein a slant crystal comprises a point on one end.

9. The apparatus of claim 1, wherein the base is made of a non-electromagnetically conductive material.

10. The apparatus of claim 1, wherein each slant crystal is coupled to a slant linear conductor with an electromagnetically conductive material.

11. The apparatus of claim 1, wherein each slant crystal is coupled to a slant linear conductor closer to the base linear conductors than to the annular element.

12. The apparatus of claim 1, wherein each slant crystal is coupled to a slant linear conductor within the interior of the apparatus.

13. The apparatus of claim 1, wherein the slant linear conductors and base linear conductors form a right equilateral square pyramid shape with a slope of 51.34 to 52.34 degrees.

14. An apparatus, the apparatus comprising:
four base linear conductors coupled together to form a right rectangle, wherein each base linear conductor is electromagnetically isolated from the two other base linear conductors to which it is coupled;
a base supporting the base linear conductors;
four slant linear conductors, wherein each slant linear conductor is coupled to an intersection of two base linear conductors and also coupled to the other three slant linear conductors to form a right pyramid shape with an apex, and wherein each slant linear conductor is electromagnetically isolated from the base linear conductors and from the other slant linear conductors;
an annular element coupled to and encircling the apex, wherein the annular element is electromagnetically isolated from the slant linear conductors;
a central linear conductor coupled to the annular element below the apex, wherein the central linear conductor extends perpendicularly towards the base and is coupled to the base, and wherein the central linear conductor is in electromagnetic communication with the annular element;
four slant crystals, wherein each slant crystal is coupled to a slant linear conductor; and
a vertical crystal, wherein the vertical crystal is coupled to the central linear conductor.

15. The apparatus of claim 14, wherein the vertical crystal and slant crystals are natural crystals.

16. The apparatus of claim 14, wherein a slant crystal comprises a point on one end.

17. The apparatus of claim 14, wherein each slant crystal is coupled to a slant linear conductor with an electromagnetically conductive material.

18. The apparatus of claim 14, wherein each slant crystal is coupled to a slant linear conductor closer to the base linear conductors than to the annular element.

19. The apparatus of claim 14, wherein each slant crystal is coupled to a slant linear conductor within the interior of the apparatus.

20. The apparatus of claim 14, wherein the slant linear conductors and base linear conductors form a right equilateral square pyramid shape with a slope of 51.34 to 52.34 degrees.
